(19) United States
(12) Patent Application Publication
(10) Pub. No.: US 2024/0265792 A1
(43) Pub. Date: Aug. 8, 2024

(54) Electronic Monitoring System and Method with Dynamic Activity Zone Adjustment

(71) Applicant: Arlo Technologies, Inc., Carlsbad, CA (US)

(72) Inventor: Mark Kretsch, Carlsbad, CA (US)

(21) Appl. No.: 18/106,776

(22) Filed: Feb. 7, 2023

(51) Int. Cl. G08B 13/196; G08B 15/00

(52) U.S. Cl. CPC G08B 13/19606; G08B 13/1961; G08B 15/00

(57) ABSTRACT

An area monitoring system is provided that allows dynamic selection of activity zones in which motion serves to trigger a transmission of an alert from the camera. Activity zones may be changed according to motion detected by one or more motion sensors having a field-of-view at least partly outside of the field-of-view of the camera.

### BACKGROUND OF THE INVENTION

### 1. Field of the Invention

The present invention relates to an electronic monitoring system and, more particularly, to an electronic monitoring system that allows for an activity zone defined in a camera field-of-view to be changed depending on data from other sensors, for example, data from outside of the field-of-view of the camera.

### 2. Discussion of the Related Art

Cameras have long been used as a part of monitoring and/or surveillance systems. More recently, cameras have been coupled with electronic sensors to detect triggering events, such as a detected motion, to alert the user and/or initiate image or video capturing a transmission of an area once a triggering event has occurred.

In such systems, background motion (traffic, etc.) can produce undesired, repeated false triggering causing undesired transmissions and recording. For this reason, it is known to allow the user to define custom “activity zones” within the camera field-of-view. Such activity zones define a limited area in which triggering will occur and may include areas of interest while avoiding areas where there may be background nuisance motion. In one example, activity zones may be drawn on an image from the camera, for example, positioned to cover a front entranceway, but to exclude a nearby moving tree branch or traffic on the street. Multiple different activity zones can be defined for use at the same time (in different portions of the image) or at different times (for example, during the day or the evening).

While these monitoring systems are versatile and work very well for their intended purpose of monitoring an area, they have limitations. For example, the activity zone of a given camera can be changed only by user input to a user device. The activity zone cannot be changed or redefined in response to sensed activity outside of the camera's field of view. The system thus if prone to false triggers by activating its activity zone only when motion is detected by the camera's sensor.

### SUMMARY OF THE INVENTION

In accordance with a first aspect of the invention, a monitoring system is provided that allows activity zones or sets of activity zones of a camera to be changed dynamically according to sensed activity within a field-of-view different from the camera's field-of-view. For example, the data may be detected by separate passive infrared (PIR) sensors positioned to the left and/or right of the camera. The ability to flexibly redefine the current activity zone sets, based on the environment outside or independent of the camera field-of-view, allows the user to define activity zones that might otherwise be prone to false triggers by activating those activity zones only when predicate motion is detected by a separate sensor.

The system may include a camera having a first field-of-view and a presence detector having a second field-of-view that is not coextensive with the first field of view, i.e., that is at least partly outside of the first field of view. At least one electronic processor receives image data from the camera and a signal from the presence detector to (a) respond to activity in a current activity zone set defining a subset of the first field-of-view to transmit an alert to a user and (b) respond to signal from the presence detector to change the current activity zone set from a first activity zone set defining a first subset of the first field-of-view to a second activity zone set defining a second subset of the first field-of-view.

The presence detector may be a motion detector such as a PIR detector.

The system may include two presence detectors and may respond to a signal from the second detector to change the current activity zone set from the second activity zone set.

A nonlimiting feature of this embodiment is to allow camera activity zones to be changed according to other detected activity to provide a contingent sensitivity that can either reduce false triggering or provide more sophisticated triggering of alerts, for example, by inferring a trajectory of motion.

These and other features and advantages of the invention will become apparent to those skilled in the art from the following detailed description and the accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Exemplary embodiments of the invention are illustrated in the accompanying drawings in which like reference numerals represent like parts throughout, and in which:

FIG. 1 is a top plan view of a wall-mountable escutcheon providing independently articulated floodlights and a camera, each incorporating a motion detector and generally showing the fields-of-view of the motion detector and the camera;

FIG. 2 is a front elevational view of the escutcheon of FIG. 1, showing the sensing regions of the motion detectors, the camera lens and floodlight elements, and camera illumination, and showing an electronic controller that may execute a stored program and a wireless transceiver for communication with one or more remote portable devices;

FIG. 3 is an electronic block diagram showing the circuitry controlling and associated with the motion detectors, cameras, and floodlights of FIGS. 1 and 2 under computer control;

FIG. 4 is a diagram showing the different fields-of-view of the camera and the motion detectors of the floodlights of FIG. 1;

FIG. 5 is a simplified perspective view of an installation of the escutcheon of FIGS. 1 and 2 on a building showing the different fields-of-view;

FIG. 6 is a flowchart showing execution of the stored program by the computer of FIG. 3 for defining and using alternative activity zones sets; and

FIG. 7 is simplified representation of three activity zone sets.

### DETAILED DESCRIPTION

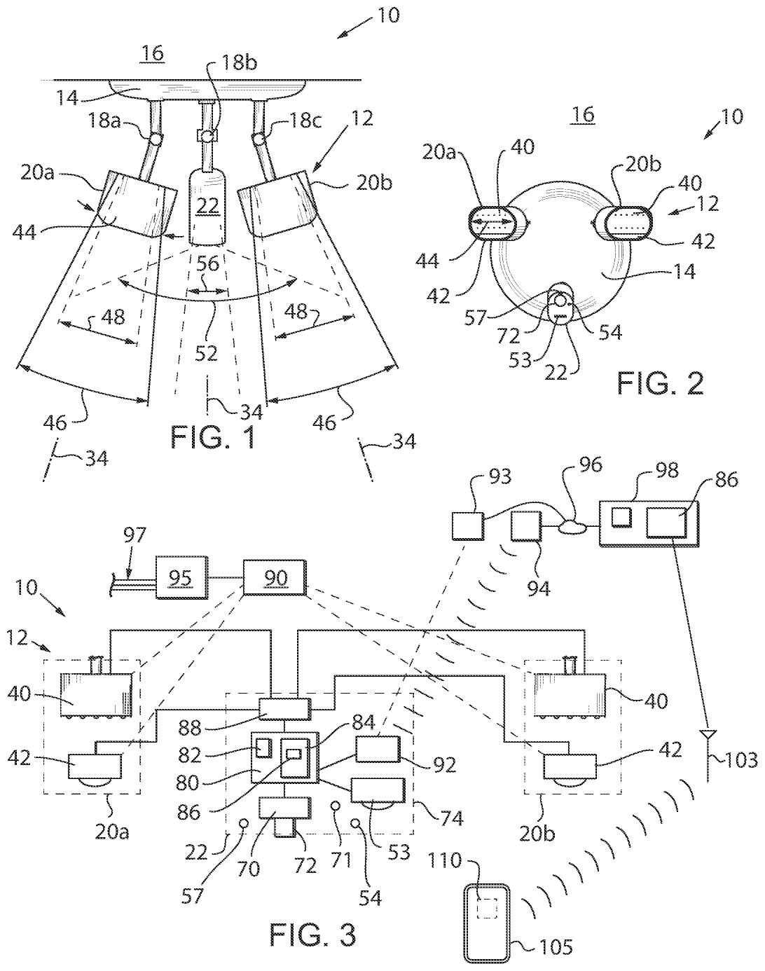

Referring now to FIGS. 1 and 2, in accordance with an aspect of the invention, an electronic system 10 for real-time monitoring may include a camera/floodlight assembly 12 configured to monitor an area of interest. The system 10 may additionally include more than one such camera/floodlight assembly 12 and/or other monitoring and/or imaging devices or assemblies such as a stand-alone surveillance camera, a video doorbell, smoke detectors, etc. These devices and assemblies may communicate wirelessly with each other and also may communicate wirelessly with an external server and one or more user devices via a gateway router or simply a router, possibly with the assistance of a base station as described below.

Still referring to FIGS. 1 and 2, the camera/floodlight assembly 12 has an escutcheon 14, for example, that may mount against a building wall 16, a soffit, a fence, a light pole, or the like and which provides a support plate for the camera/floodlight assembly 12. The escutcheon 14 may have a hollow rear face to receive and cover electrical connections to an electrical main or the like as well as physical connections of the escutcheon 14 to the wall 16 by screws or bolts as is generally understood in the art.

The front surface of the escutcheon 14 may support a number (three in this embodiment) articulated joints 18a-18c extending forward therefrom to attach, respectively, to rear surfaces of a first motion detector floodlight 20a, an imaging device or camera module 22, and a second motion detector floodlight 20b. Unless otherwise specified, the presence of a numerical reference character such as “20,” unaccompanied by an alphabetical designator such as “a” or “b,” should be understood to refer to any or all of the devices designated by a combination of the numerical and alphabetical components. Hence, “20” standing alone should be understood to refer to either or both of 20a and 20b and “18” standing alone should be understood to refer to any or all of 18a, 18b, and 18c.

Each articulated joint 18 may provide for a fixed portion attached to the escutcheon 14 and a movable portion attached to the rear surfaces of the motion detector, floodlights 20a and 20b, and camera module 22. In one embodiment, the movable portion may be positionable with respect to the escutcheon 14 at various angles in elevation and azimuth and may pivot about a central axis 34 generally aligned with the axes of sensitivity of the motion detector, floodlights 20a and 20b, and camera module 22. In a typical orientation shown in FIG. 2, the elevation will be vertical, the azimuth 30 will be horizontal, and central axis 34 will extend generally in a horizontal direction when the articulated joint 18 is centered in azimuthal and elevational movement.

Referring again to FIGS. 1 and 2, each of the motion detector floodlights 20a and 20b will include an upper floodlight assembly 40 that typically has multiple LED emitters directed forwardly to emit in excess of 500 lumens generally along the central axis 34 when the motion detector floodlight 20a or 20b is centered in azimuth and elevation. Positioned beneath the floodlight assembly 40 is a forward-facing passive infrared (PIR) detector 42. The floodlight assembly 40 will generally have a greatest extent along a width 44 (typically horizontally oriented) matching a greatest width of its illumination pattern 46 and also matching a greatest width of the field-of-view (FOV) 48 of the associated PIR detector 42.

Referring still to FIGS. 1, 2 and 3, the camera module 22 includes at least a video camera 70 (FIG. 3), and may additionally include other components that may be found in imaging devices of monitoring systems, including one or more of a motion sensor, a microphone, a speaker, and an alarm. The camera 70 has a forward-facing wide-angle lens 72 providing a camera field-of-view (FOV) 52 that may, for example, be greater than 100°, and typically greater than 160° in azimuth. The camera module 22 will also include an integrated PIR detector 53 having a field-of-view width 56 centered on the field-of-view 58. This FOV width 56 may be smaller than that field-of-view 58. A light source 57 is provided on a front face of the camera module 22 that emits infrared or visible light to provide light for the camera 70, but at an intensity generally much lower than the light provided by the floodlight assembly 40. An indicator light 54 may be provided indicating activation of the PIR detector 53 by motion of an infrared-emitting body, such as an individual passing within the field-of-view width 56. An ambient light sensor 71 (FIG. 3) is provided, for example, to suppress operation of the floodlight assembly during daylight hours.

Referring now to FIG. 3, in one embodiment, the camera module 22 may provide for a camera 70 with a lens assembly 72 for obtaining video images, for example, at 2K HDR using a CMOS sensor or other sensing technology. A housing 74 of the camera module 22 holding the camera may also hold the PIR detector 53 with both the PIR detector 53 and camera 70 communicating with an internal microcontroller 80. The microcontroller 80, for example, may provide for a processor 82 and a non-transient electronic memory 84 holding a stored program 86 to be executed by the microcontroller 80, at least in part, as will be discussed below. As is generally understood in the art, the microcontroller 80 may also include one or more interface lines for communicating with the camera 70, the PIR detector 53, the ambient light detector 71, and an interface 88 (for example, the I²C protocol) allowing communication with other elements of the camera/floodlight assembly 12. In particular, the interface 88 may communicate with floodlight assemblies 40 of each of the motion detector floodlights 20a and 20b to provide signals independently turning the floodlight assemblies 40 on and off, and with the PIR detectors 42 of each of the motion detector floodlights 20a and 20b to receive signals therefrom. As will be discussed below, the floodlight assemblies 40 generally will include necessary driver circuitry so that they can be activated by the camera module 22 by remote command or be dependent on the receipt of electrical signals indicating motion from the PIR detectors 42 or 53.

Importantly, the microcontroller 80 may also communicate with a wireless transceiver 92, for example, using the IEEE 802.11 standards in accordance with the Wi-Fi™ communication protocol. The wireless transceiver 92 may communicate with a base station 93 or wireless router 94, for example, in the user's home, and via either of these devices, through the Internet 96 with remote server 98 including one or more computer processors. The remote server 98, which may be a cloud-based server, may in turn communicate with the cellular network 103 providing communication with user devices, typically in the form of portable wireless devices 105 such as a smart phone, tablet, or laptop. It also could provide communications with one or more stationary devices such as a PC. As is understood in the art, such wireless portable devices 105 may include one or more internal processors, a computer memory holding stored programs in the form of applications, a wireless transceiver, and a display such as a touchscreen or the like allowing for inputs from a user and the display of graphical or text information, as well as a speaker and microphone for delivering and receiving voice commands. Such portable wireless devices 105 are typically battery-powered so as to be carried by a user if desired during the processing be described herein.

Generally, it will be understood that the logic to be described with respect to the operation of the system 10 may be distributed among or performed in any one of the multiple processors variously within the camera module 22, a base station 93, and/or a router 94 in the user's house, or the central server 98.

An internal battery 90, provided with recharging capabilities from charger unit 95 connected to line voltage 97, may provide power to each of the floodlight assemblies 40, the circuitry of the PIR detectors 42 of the floodlights 20a and 20b, and the circuitry associated with the camera module 22 within housing 74.

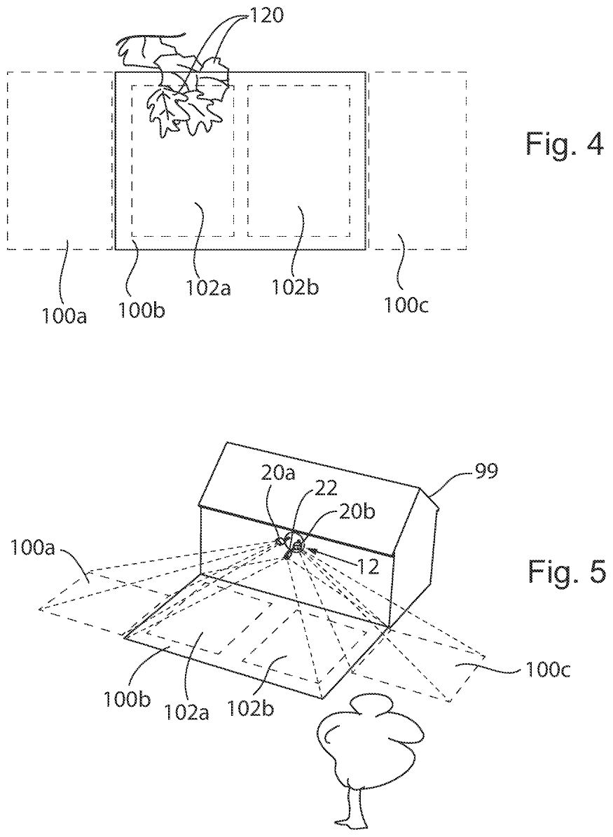

Referring now to FIGS. 4 and 5, when the camera/floodlight assembly 12 is attached to a structure 99 such as a home, building, post, fence, or the like, the PIR detectors 42 and 53 in the respective individual motion detector floodlights 20a, 20b and camera module 22 may be independently positioned and aligned to define multiple fields-of-view 100a, 100c (of the PIR detectors), and 100b (of the camera 70). These multiple fields-of-view 100a, 100b, and 100c may be located freely at different elevational and azimuthal positions, being generally left, center, and right positions with respect to the structure 99. The multiple fields-of-view 100a, 100b, and 100c may also extend different distances from the structure 99. This is in contrast to a conventional camera-attached, wide-angle PIR, which can provide only a linear contiguous activity zone at a fixed elevation and azimuth with respect to the camera module 22. While the fields-of-view 100 are shown as approximately square, in practice they may be much wider than tall. The ability to swivel the PIR detectors 42 in their respective motion detector floodlights 20 using the pivoting of joint 18 allows these elongated zones to be flexibly oriented, for example, angled or rotated.

This freedom of positioning of the motion detector floodlights 20 independent of the camera module 22 allows additional flexibility in locating the fields-of-view 100 discontinuously or at different elevations in areas of interest. In all cases, the second and third FOVs of the PIR detectors 42 of the first and second floodlights 20a and 20b are non-coextensive with the first FOV of the camera PIR detector 53, though they may overlap with the first FOV.

It should be noted that the presence detector(s) formed by one or more of the PIR detectors could be replaced by other motion detectors, such as microphone sensors, or even other types of detectors capable of detecting the presence of an object in a defined area, such as microphone or ultrasonic sensors that detects sound.

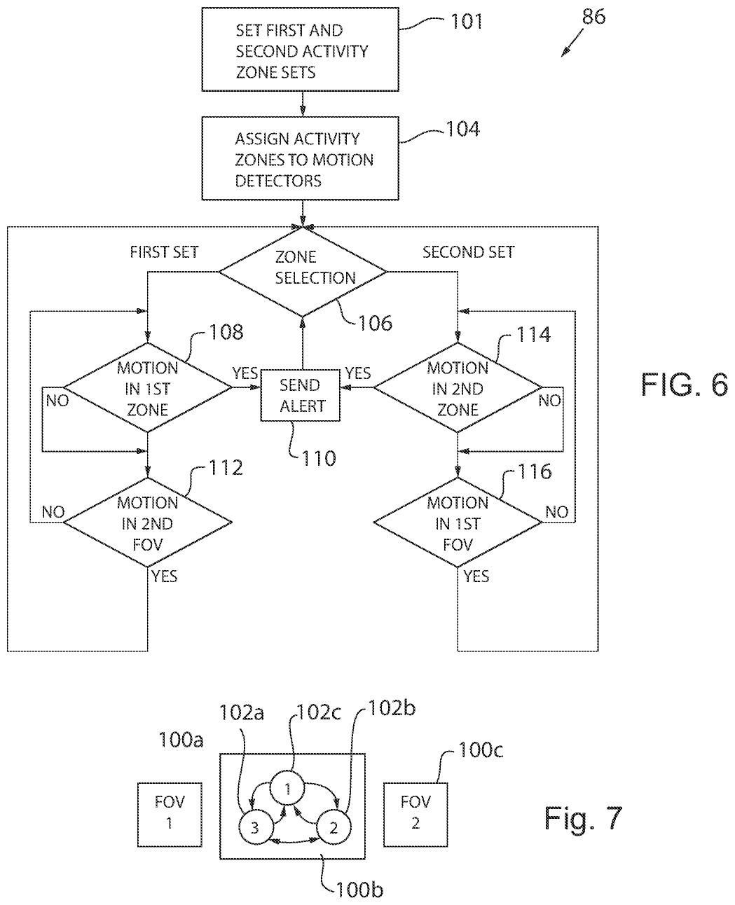

Referring now to FIGS. 4 and 6, as indicated by process block 101, the program 86, may provide a user interface allowing the definition of one or more activity zone sets 102a and 102b (generally providing one or more activity zones, but here depicting only a single activity zone for each set) within the field-of-view 100b of the camera module 22. This made be done, for example, by presenting the user with an image from the camera, for example, on a display screen, and allowing the user to draw the activity zone sets 102 on that image, for example, by defining polygon end points.

As indicated by process block 104, the individual activity zone sets 102a and 102b may then be associated with the field-of-views 100a or 100b of the PIR sensors on floodlights 20a and 20b. Typically, but not necessarily, each activity zone set 102 will be associated with the PIR sensor of the floodlight 20 to which it is closest (determined either by its center of mass or closest extent) so that the activity zone set 102a is associated with the field-of-view of the PIR sensor of floodlight 20a and the activity zone set 102b is associated with the PIR sensor of the floodlight 20b to which it is closer. This may be a default condition that may be overridden by the user.

When the monitoring system 10 is actively monitoring, one of the activity zone sets 102 may be selected according to decision block 106 to be a current activity zone set, or all activities zone sets 102 may be deactivated. Afterwards, the current activity zone set will be selected according to the most recent activity in the fields-of-view 100a and 100c. Thus, for example, if activity was most recently detected in field-of-view 100a, the activity zone set 102a may be active (the current activity zone) meaning that motion is detected in the activity zone set 102a and not in activity zone set 102b. More specifically decision block 108, detecting activity in activity zone set 102a, triggers a monitoring action such as a notification to the user and/or recording of video or images of the field-of-view 100b per process block 110.

The activity zone set 102a will remain active until motion is detected in field-of-view 100c per decision block 112 or a predetermined timeout value has elapsed (not shown as a process block), in which case the program returns to decision block 106, which makes the activity zone set 102b active (the current activity zone), simultaneously deactivating the sensitivity of activity zone set 102a so that motion must be detected in that activity zone set 102b at decision block 114 to initiate transmit the alert at process block 110.

In this program state, the detection of motion in field-of-view 100a decision block 116 (or predetermined timeout value elapsing) will operate to switch the current activity zone back to activity zone set 102a as discussed above.

Referring to FIG. 4, in one example situation, an important monitoring zone circumscribed by activity zone set 102a, may, for example, have a nuisance element 120, for example, occasional traffic, moving leaves, etc., that make it undesirable as a static activity zone because it would produce multiple false notifications. By making the response to motion in the activity zone set 102a contingent on motion in field-of-view 100a, however, this region of activity zone set 102a may be monitored with greatly reduced false triggering. Further, a monitoring logic can be implemented, for example, if field-of-view 100a provides part of a walkway or driveway and activity zone set 102a encompasses a later part of the walkway or driveway, as sensitivity can be restricted to people or objects moving along the walkway or driveway.

Referring now to FIG. 7, it will be appreciated that more than two activity zone sets can be defined, for example, activity zone sets 102a, 102b, and 102c. For example, activity zone set 102c may be a default activity zone set that is returned to, for example, after a timeout when no motion is detected in fields-of-view 100a and 100b. Motion in field-of-view 100a may then activate activity zone set 102a, and motion in field-of-view 100c may activate activity zone set 102b as discussed above. In this case, each of the activity zone sets 102a-102c may again comprise a single contiguous activity zone. Alternatively, one activity zone set may be formed of activity zone sets 102a and 102b (that is, a set of two activity zones), and a second activity zone set may be activity zone set 102b and 102c. As used herein, an activity zone set must always include at least one activity zone, and the set must include at least one member, as the term would ordinarily be understood outside of the field of mathematics.

As is generally understood to those of ordinary skill in the art, the various processors described including those in the server 98, the camera module 22, and in the portable wireless device 105, may employ any standard architecture and may include, but are not limited to: a central processing unit (CPU), an array processor, a vector processor, a digital signal processor (DSP), a field-programmable gate array (FPGA), a programmable logic array (PLA), an application-specific integrated circuit (ASIC), programmable logic circuitry, and a controller. The memory associated with any of these processors can store instructions of the program 86 and/or program data as well as video data and the like. The memory can include volatile and/or non-volatile memory. Examples of suitable memory include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, disks, drives, or any other suitable storage medium, or any combination thereof.

An exemplary camera module 22 capable of implementing aspects of the invention is commercially available under the Arlo Ultra brand from Arlo Technologies, Inc. in Carlsbad, California, US. An exemplary base station 93 capable of incorporating aspects of the invention is commercially available under the Arlo SmartHub brand from Arlo Technologies in Carlsbad, California, US. Alternatively, base station 93 may be omitted, and its circuitry and functionality may be provided, at least in part, in the router 94, and in other devices such as the server 98 and/or the camera module 22.

Although the best mode contemplated by the inventors of carrying out the present invention is disclosed above, practice of the above invention is not limited thereto. It will be manifest that various additions, modifications, and rearrangements of the features of the present invention may be made without deviating from the spirit and the scope of the underlying inventive concept.

What is claimed is:

1. An electronic monitoring system comprising:
a camera having a first field-of-view and operating to generate image data of the first field-of-view;
a presence detector having a second field-of-view and operating to generate a signal upon motion in the second field-of-view, the second field of view being non-coextensive with the first field of view; and
an electronic processor executing a stored program and receiving the image data from the camera and the motion signal from the motion detector to:
(a) respond to activity in a current activity zone set defining a subset of the first field-of-view to transmit an alert to a user; and
(b) respond to the signal from the presence detector to change the current activity zone set from a first activity zone set defining a first subset of the first field-of-view to a second activity zone set defining a second subset of the first field-of-view.

2. The electronic monitoring system of claim 1, wherein the presence detector is a motion detector, and the signal is a motion signal.

3. The electronic monitoring system of claim 2, wherein the electronic processor further operates to respond to an absence of a motion signal for a predetermined period of time to change the current activity zone set from the second activity zone set to the first activity zone set.

4. The electronic monitoring system of claim 2, wherein the motion detector is mounted for independent angulation in azimuth with respect to the camera.

5. The electronic monitoring system of claim 2, further including a second motion detector having a third field-of-view including an area outside of the first field-of-view and second field-of-view and operating to generate a motion signal upon motion in the third field-of-view, the second motion detector being mounted for independent angulation in azimuth with respect to the camera; and
wherein the electronic processor operates further to respond to the second motion signal from the motion detector to change the current activity zone set.

6. The electronic monitoring system of claim 5, wherein the first and second motion detectors are mounted for independent angulation in elevation with respect to the camera and with respect to each other.

7. The electronic monitoring system of claim 5, wherein at least one of the first and second motion detectors further includes a floodlight controllable by the electronic motion signal of an associated motion detector.

8. The electronic monitoring system of claim 5, further including a third motion detector having a fourth field-of-view fixed with respect to the camera first field-of-view.

9. The electronic monitoring system of claim 1, wherein the second field of view includes an area outside of the first field-of-view, and wherein the second activity zone set is closer to the second field-of-view than is the first activity zone set.

10. The electronic monitoring system of claim 1, wherein the electronic process further operates to allow a user to define multiple activity zones and to designate one or more of the multiple activity zones as the first activity zone set and one or more of the multiple activity zones as the second activity zone set.

11. A method of area monitoring comprising:
(a) generating image data of a first field-of-view with a camera having a first field-of-view;
(b) generating a presence signal upon detecting the presence of an object in a second field-of-view including an area outside of the first field-of-view with a presence detector having a second field-of-view;
(c) responding to activity in a current activity zone set defining a subset of the first field-of-view to transmit an alert to a user;
(d) responding to the presence signal from the presence detector to change the current activity zone set from a first activity zone set defining a first subset of the first field-of-view to a second activity zone set defining a second subset of the first field-of-view.

12. The method of claim 11, wherein the presence signal is a motion signal detected by a motion detector.

13. The method of claim 12, further including responding to an absence of a motion signal for a predetermined period of time to change the current activity zone set from the second activity zone set to the first activity zone set.

14. The method of claim 12, wherein the motion detector is mounted for independent angulation in azimuth with respect to the camera.

15. The method of claim 12, further including a second motion detector having a third field-of-view including an area outside of the first field-of-view and second field-of-view and operating to generate a motion signal upon motion in the third field-of-view and mounted for independent angulation in azimuth with respect to the camera; and
further responding to the second motion signal from the motion detector to change the current activity zone set.

16. The method of claim 15, wherein the first and second motion detectors are mounted for independent angulation in elevation with respect to the camera and with respect to each other.

17. The method of claim 15, further including a third motion detector having a fourth field-of-view fixed with respect to the camera first field-of-view.

18. The method of claim 11, wherein the second activity zone set is closer to the second field-of-view than is the first activity zone set.

19. The method of claim 11, further including designating one or more activity zones as the first activity zone set and one or more activity zones as the second activity zone set.

20. A system comprising:
an electronic monitoring system comprising:
a camera having a first field-of-view and operating to generate image data of the first field-of-view;
a first motion detector having a second field-of-view including an area outside of the first field-of-view and operating to generate a motion signal upon motion in the second field-of-view;
a second motion detector having a third field-of-view including an area outside of the first field-of-view and outside of the second field-of-view and operating to generate a second motion signal upon motion in the second field-of-view;
wherein the first and second motion detectors are mounted for independent angulation in elevation with respect to the camera; and
wherein the first and second motion detectors further include respective first and second floodlights controllable by the electronic motion signal of at least one of the first and second motion detectors; and
an electronic processor executing a stored program and receiving the image data from the camera and the motion signal from the motion detector to:
(a) respond to activity in a current activity zone set that may alternatively be different activity zone sets, each different activity zone set being a subset of the first field-of-view, to transmit an alert to a user;
(b) respond to the first motion signal from the first motion detector to change the current activity zone set to a first activity zone set; and
(c) respond to the second motion signal from the second motion detector to change the current activity zone set to a first activity zone set.
